(19) United States
(12) Patent Application Publication
(10) Pub. No.: US 2026/0222536 A1
(43) Pub. Date: Jul. 30, 2026

(54) Method and Apparatus of Default Model Derivation for Cross-Component Model Merge Mode in Video Coding System

(71) Applicant: MEDIATEK INC., Hsinchu City (TW)

(72) Inventors: Hsin-Yi TSENG, Hsinchu City (TW); Chia-Ming TSAI, Hsinchu City (TW); Cheng-Yen CHUANG, Hsinchu City (TW); Ching-Yeh CHEN, Hsinchu City (TW); Chih-Wei HSU, Hsinchu City (TW); Tzu-Der CHUANG, Hsinchu City (TW); Yi-Wen CHEN, San Jose, CA (US)

(21) Appl. No.: 19/146,075

(22) PCT Filed: Jan. 16, 2024
(86) PCT No.: PCT/CN2024/072528

§ 371 Date: Jul. 7, 2025

Related U.S. Application Data
(60) Provisional application No. 63/439,254, filed on Jan. 16, 2023.

(51) Int. Cl. H04N 19/105; H04N 19/159; H04N 19/186; H04N 19/196

(52) U.S. Cl. CPC H04N 19/105; H04N 19/159; H04N 19/186; H04N 19/196

(57) ABSTRACT

A method and apparatus of deriving a default cross-component candidate for merge candidate list. According to this method, a default cross-component prediction candidate is derived, wherein the target cross-component model associated with the default cross-component prediction candidate is derived based on reconstructed first-colour samples and second-colour samples of a region corresponding to the current block. A prediction candidate list is derived, wherein the default cross-component prediction candidate is inserted into the prediction candidate list. The second-colour block is encoded or decoded using prediction data generated from the first-colour block according to the target cross-component model when the default cross-component prediction candidate is selected from the prediction candidate list.

### CROSS REFERENCE TO RELATED APPLICATIONS

The present invention is a non-Provisional Application of and claims priority to U.S. Provisional Patent Application No. 63/439,254, filed on Jan. 16, 2023. The U.S. Provisional Patent Application is hereby incorporated by reference in its entirety.

### FIELD OF THE INVENTION

The present invention relates to video coding system. In particular, the present invention relates to deriving default cross-component models for a merge candidate list in a video coding system.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

The VVC standard incorporates various new coding tools to further improve the coding efficiency over the HEVC standard.

In the present invention, methods and apparatus to improve the performance by introducing new default cross-component candidates are disclosed.

### BRIEF SUMMARY OF THE INVENTION

A method and apparatus of deriving a default cross-component candidate for a merge candidate list are disclosed. According to this method, input data associated with a current block comprising a first-colour block and a second-colour block are received, wherein the input data comprise pixel data to be encoded at an encoder side or data associated with the current block to be decoded at a decoder side. A default cross-component prediction candidate is derived, wherein the target cross-component model associated with the default cross-component prediction candidate is derived based on reconstructed first-colour samples and second-colour samples of a region corresponding to the current block. A prediction candidate list is derived, wherein the default cross-component prediction candidate is inserted into the prediction candidate list. The second-colour block is encoded or decoded using prediction data generated from the first-colour block according to the target cross-component model when the default cross-component prediction candidate is selected from the prediction candidate list.

In one embodiment, the region corresponding to the current block is defined by x and y coordinates of location of the region corresponding to the current block, region width and region height.

In one embodiment, the size of the region corresponding to the current block is the same as block size of the current block. In another embodiment, the size of the region corresponding to the current block is pre-defined.

In one embodiment, the location of the region corresponding to the current block is identified by an offset position from a target current position in a reconstructed area, and wherein the target current position corresponds to an upper-left position, middle position or lower-right position of the current block. In one embodiment, the offset position is selected from a group of candidate locations, and wherein x-coordinates of the candidate locations are proportional to a first base and γ-coordinates of the candidate locations are proportional to a second base, and the first base and the second base are positive values. In one embodiment, the first base corresponds to width of the current block and the second based corresponds to height of the current block. In one embodiment, the first base and second base are pre-defined. In one embodiment, the x-coordinates of the candidate locations are generated by multiplying the first base with a first set of numbers and the y-coordinates of the candidate locations are generated by multiplying the second base with a second set of numbers. In one embodiment, the first set of numbers comprises 0, ±1, . . . , ±M and the second set of numbers comprises 0, ±1, . . . , ±N, and wherein M and N are positive integers greater than 0. In another embodiment, the first set of numbers comprises 0, ±1, . . . , ±M and the second set of numbers comprises 0, ±½, . . . , ±N/2, and wherein M and N are positive integers greater than 0.

In one embodiment, the target cross-component model corresponds to CCCM (Convolutional Cross-Component Model). In another embodiment, the target cross-component model corresponds to CCCM (Convolutional Cross-Component Model) or MM-CCCM (Multiple Model CCCM). In yet another embodiment, the target cross-component model corresponds to CCLM (Cross-Component Linear Model). In yet another embodiment, the target cross-component model belongs to a model group comprising CCLM (Cross-Component Linear Model), MMLM (Multiple Model CCLM), CCCM (Convolutional Cross-Component Model), and MM-CCCM (Multiple Model CCCM).

In one embodiment, when the target cross-component model associated with the default cross-component prediction candidate is derived based on the reconstructed first-colour samples and second-colour samples of a non-adjacent region of the current block, the target cross-component model corresponds to any type of cross-component models. In another embodiment, the target cross-component model corresponds to some particular types of cross-component models.

### BRIEF DESCRIPTION OF THE DRAWINGS

FIG. 1A illustrates an exemplary adaptive Inter/Intra video encoding system incorporating loop processing.

FIG. 1B illustrates a corresponding decoder for the encoder in FIG. 1A.

FIG. 2 shows an example of the location of the left and above samples and the sample of the current block involved in the LM_LA mode.

FIG. 3 shows an example of classifying the neighbouring samples into two groups according to multiple mode CCLM.

FIG. 4A illustrates an example of the CCLM model.

FIG. 4B illustrates an example of the effect of the slope adjustment parameter “u” for model update.

FIG. 5 illustrates an example of spatial part of the convolutional filter.

FIG. 6 illustrates an example of reference area with paddings used to derive the filter coefficients.

FIG. 7 illustrates the 16 gradient patterns for Gradient Linear Model (GLM).

FIG. 8 illustrates the neighbouring blocks used for deriving spatial merge candidates for VVC.

FIG. 9 illustrates the possible candidate pairs considered for redundancy check in VVC.

FIG. 10 illustrates an exemplary pattern of the non-adjacent spatial merge candidates.

FIG. 11 illustrates examples of CCM information propagation, where the blocks with dash line (i.e., A, E, G) are coded in cross-component mode (e.g., CCLM, MMLM, GLM, CCCM).

FIG. 12 illustrates an example of inheriting temporal neighbouring model parameters.

FIGS. 13A-B illustrate two search patterns for inheriting non-adjacent spatial neighbouring models.

FIGS. 14A-B illustrate examples for constructing the history table of the current region from the history table of the region having the same beginning geometric position of the current region (FIG. 14A) or from the history table of the region containing the centre geometric position of the current region (FIG. 14B).

FIG. 15 illustrates an example of neighbouring templates for calculating model error.

FIG. 16 illustrates a flowchart of an exemplary video coding system that incorporates a scheme to derive a default cross-component candidate according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

Some new tools relevant to the present invention are reviewed as follows.

### Cross-Component Linear Model (CCLM) Prediction

To reduce the cross-component redundancy, a cross-component linear model (CCLM) (sometimes abbreviated as LM mode) prediction mode is used in the VVC, for which the chroma samples are predicted based on the reconstructed luma samples of the same CU by using a linear model as follows:

$${pred}_{C} ( i , j ) = α \cdot {rec}_{L}^{′} ( i , j ) + β \qquad ( 1 )$$

where pred_{C}(i, j) represents the predicted chroma samples in a CU and rec_{L}′(i, j) represents the down-sampled reconstructed luma samples of the same CU.

The CCLM parameters (α and β) are derived with at most four neighbouring chroma samples and their corresponding down-sampled luma samples. Suppose the current chroma block dimensions are W×H, then W′ and H′ are set as
W′=W, H′=H when LM_LA mode is applied;
W′=W+H when LM_A mode is applied;
H′=H+W when LM_L mode is applied.

The above neighbouring positions are denoted as S[0, −1] . . . . S[W′−1, −1] and the left neighbouring positions are denoted as S[−1, 0] . . . . S[−1, H′−1]. Then the four samples are selected as
S[W′/4, −1], S[3*W′/4, −1], S[−1, H′/4], S[−1, 3*H′/4] when LM_LA mode is applied and both above and left neighbouring samples are available;
S[W′/8, −1], S[3*W′/8, −1], S[5*W′/8, −1], S[7*W′/8, −1] when LM_A mode is applied or only the above neighbouring samples are available;
S[−1, H′/8], S[−1, 3*H′/8], S[−1, 5*H′/8], S[−1, 7*H′/8] when LM_L mode is applied or only the left neighbouring samples are available.

The four neighbouring luma samples at the selected positions are down-sampled and compared four times to find two larger values: x⁰_{A} and x¹_{A}, and two smaller values: x⁰_{B} and x¹_{B}. Their corresponding chroma sample values are denoted as y⁰_{A}, y¹_{A}, y⁰_{B} and y¹_{B}. Then x_{A}, x_{B}, y_{A} and y_{B} are derived as:

$$\begin{matrix}Xa = ( x 0 A + x 1 A + 1 ) >> 1 ; \\ Xb = ( x 0 B + x 1 B + 1 ) >> 1 ; \\ Ya = ( y 0 A + y 1 A + 1 ) >> 1 ; \\ Yb = ( y 0 B + y 1 B + 1 ) >> 1\end{matrix} \qquad ( 2 )$$

Finally, the linear model parameters α and β are obtained according to the following equations.

$$α = \frac{{Y}_{a} - {Y}_{b}}{{X}_{a} - {X}_{b}} \qquad ( 3 )$$

$$β = {Y}_{b} - α \cdot {X}_{b} \qquad ( 4 )$$

FIG. 2 shows an example of the location of the left and above samples and the sample of the current block involved in the LM_LA mode. FIG. 2 shows the relative sample locations of N×N chroma block 210, the corresponding 2N×2N luma block 220 and their neighbouring samples (shown as filled circles).

The division operation to calculate parameter a is implemented with a look-up table. To reduce the memory required for storing the table, the diff value (difference between maximum and minimum values) and the parameter a are expressed by an exponential notation. For example, diff is approximated with a 4-bit significant part and an exponent. Consequently, the table for 1/diff is reduced into 16 elements for 16 values of the significand as follows:

$$DivTable [ ] = \{ 0 , 7 , 6 , 5 , 5 , 4 , 4 , 3 , 3 , 2 , 2 , 1 , 1 , 1 , 1 , 0 \} \qquad ( 5 )$$

This would have a benefit of both reducing the complexity of the calculation as well as the memory size required for storing the needed tables.

Besides the above template and left template can be used to calculate the linear model coefficients together, they also can be used alternatively in the other 2 LM modes, called LM_A, and LM_L modes.

In LM_A mode, only the above template is used to calculate the linear model coefficients. To get more samples, the above template is extended to (W+H) samples. In LM_L mode, only the left template is used to calculate the linear model coefficients. To get more samples, the left template is extended to (H+W) samples.

In LM_LA mode, left and above templates are used to calculate the linear model coefficients.

To match the chroma sample locations for 4:2:0 video sequences, two types of down-sampling filters are applied to luma samples to achieve 2 to 1 down-sampling ratio in both horizontal and vertical directions. The selection of down-sampling filter is specified by a SPS level flag. The two down-sampling filters are as follows, which are corresponding to “type-0” and “type-2” content, respectively.

$${Rec}_{L}^{′} ( i , j ) = [ {rec}_{L} ( 2 i - 1 , 2 j - 1 ) + 2 \cdot {rec}_{L} ( 2 i , 2 j - 1 ) + {rec}_{L} ( 2 i + 1 , 2 j - 1 ) + {rec}_{L} ( 2 i - 1 , 2 j ) + 2 \cdot {rec}_{L} ( 2 i , 2 j ) + {rec}_{L} ( 2 i + 1 , 2 j ) + 4 ] ≫ 3 \qquad ( 6 )$$

$${Rec}_{L}^{′} ( i , j ) = {rec}_{L} ( 2 i , 2 j - 1 ) + {rec}_{L} ( 2 i - 1 , 2 j ) + 4 \cdot {rec}_{L} ( 2 i , 2 j ) + {rec}_{L} ( 2 i + 1 , 2 j ) + {rec}_{L} ( 2 i , 2 j + 1 ) + 4 ] ≫ 3 \qquad ( 7 )$$

Note that only one luma line (general line buffer in intra prediction) is used to derive the down-sampled luma samples when the upper reference line is at the CTU boundary. An exception happens if the top line of the current block is a CTU boundary. In this case, the one-dimensional filter [1, 2, 1]/4 is applied to the above neighbouring luma samples in order to avoid the usage of more than one luma line above the CTU boundary.

This parameter computation is performed as part of the decoding process, and is not just as an encoder search operation. As a result, no syntax is used to convey the α and β values to the decoder.

For chroma intra mode coding, a total of 8 intra modes are allowed for chroma intra mode coding. Those modes include five traditional intra modes and three cross-component linear model modes (i.e., {LM_LA, LM_L, and LM_A}, or {CCLM_LT, CCLM_L, and CCLM_T}). The terms of {LM_LA, LM_L, LM_A} and {CCLM_LT, CCLM_L, CCLM_T} are used interchangeably in this disclosure. The terms of LM_LA and LM_LT are also used interchangeably in this disclosure. Chroma mode signalling and derivation process are shown in Table 1. Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the centre position of the current chroma block is directly inherited.

TABLE 1
Derivation of chroma prediction mode from luma mode
when sps_cclm_enabled_flag is true

| Chroma | Corresponding luma intra prediction mode | | | | |
|---|---|---|---|---|---|
| prediction mode | 0 | 50 | 18 | 1 | X (0 <= X <= 66) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 0 | 50 | 18 | 1 | X |
| 5 | 81 | 81 | 81 | 81 | 81 |
| 6 | 82 | 82 | 82 | 82 | 82 |
| 7 | 83 | 83 | 83 | 83 | 83 |

A single binarization table is used regardless of the value of sps_cclm_enabled_flag as shown in Table 2.

TABLE 2
Unified binarization table for chroma prediction mode

| Value of | |
|---|---|
| intra_chroma_pred_mode | Bin string |
| 4 | 00 |
| 0 | 0100 |
| 1 | 0101 |
| 2 | 0110 |
| 3 | 0111 |
| 5 | 10 |
| 6 | 110 |
| 7 | 111 |

In Table 2, the first bin indicates whether it is regular (0) or LM modes (1). If it is LM mode, then the next bin indicates whether it is LM_LA (0) or not. If it is not LM_LA, next 1 bin indicates whether it is LM_L (0) or LM_A (1). For this case, when sps_cclm_enabled_flag is 0, the first bin of the binarization table for the corresponding intra_chroma_pred_mode can be discarded prior to the entropy coding. Or, in other words, the first bin is inferred to be 0 and hence not coded. This single binarization table is used for both sps_cclm_enabled_flag equal to 0 and 1 cases. The first two bins in Table 2 are context coded with its own context model, and the rest bins are bypass coded.

In addition, in order to reduce luma-chroma latency in dual tree, when the 64×64 luma coding tree node is partitioned with Not Split (and ISP is not used for the 64×64 CU) or QT, the chroma CUs in 32×32/32×16 chroma coding tree node are allowed to use CCLM in the following way:
If the 32×32 chroma node is not split or partitioned QT split, all chroma CUs in the 32×32 node can use CCLM
If the 32×32 chroma node is partitioned with Horizontal BT, and the 32×16 child node does not split or uses Vertical BT split, all chroma CUs in the 32×16 chroma node can use CCLM.

In all the other luma and chroma coding tree split conditions, CCLM is not allowed for chroma CU.

### Multiple Model CCLM (MMLM)

In the JEM (J. Chen, E. Alshina, G. J. Sullivan, J.-R. Ohm, and J. Boyce, Algorithm Description of Joint Exploration Test Model 7, document JVET-G1001, ITU-T/ISO/IEC Joint Video Exploration Team (JVET), July 2017), multiple model CCLM mode (MMLM) is proposed for using two models for predicting the chroma samples from the luma samples for the whole CU. In MMLM, neighbouring luma samples and neighbouring chroma samples of the current block are classified into two groups, each group is used as a training set to derive a linear model (i.e., a particular α and β are derived for a particular group). Furthermore, the samples of the current luma block are also classified based on the same rule for the classification of neighbouring luma samples. Three MMLM model modes (MMLM_LT, MMLM_T, and MMLM_L) are allowed for choosing the neighbouring samples from left-side and above-side, above-side only, and left-side only, respectively.

FIG. 3 shows an example of classifying the neighbouring samples into two groups. Threshold is calculated as the average value of the neighbouring reconstructed luma samples. A neighbouring sample with Rec′_{L}[x,y]<=Threshold is classified into group 1; while a neighbouring sample with Rec′_{L}[x,y]>Threshold is classified into group 2.

$$\{ \begin{matrix}{Pred}_{C} [ x , y ] = {α}_{1} \times {Rec}_{L}^{′} [ x , y ] + {β}_{1} & if {Rec}_{L}^{′} [ x , y ] \leq Threshold \\ {Pred}_{C} [ x , y ] = {α}_{2} \times {Rec}_{L}^{′} [ x , y ] + {β}_{2} & if {Rec}_{L}^{′} [ x , y ] > Threshold\end{matrix} \qquad ( 8 )$$

Accordingly, the MMLM uses two models according to the sample level of the neighbouring samples.

### Slope Adjustment of CCLM

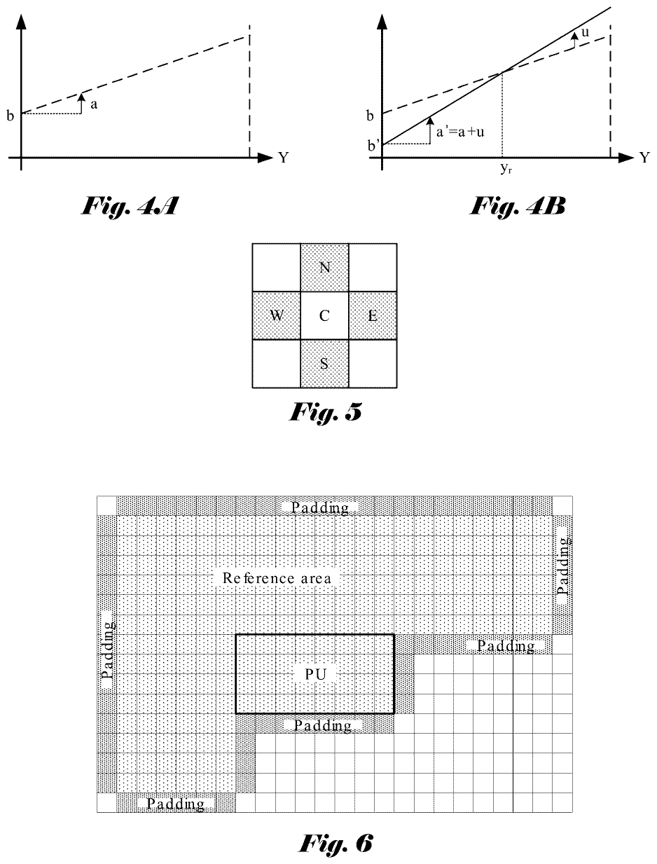

CCLM uses a model with 2 parameters to map luma values to chroma values as shown in FIG. 4A. The slope parameter “a” and the bias parameter “b” define the mapping as follows:

$$chromaVal = a * lumaVal + b$$

An adjustment “u” to the slope parameter is signalled to update the model to the following form, as shown in FIG. 4B:

$$chromaVal = {a}^{′} * lumaVal + {b}^{′}$$

$$where$$

$${a}^{′} = a + u ,$$

$${b}^{′} = b - u * {y}_{r} .$$

With this selection, the mapping function is tilted or rotated around the point with luminance value yᵣ. The average of the reference luma samples used in the model creation as yᵣ in order to provide a meaningful modification to the model. FIGS. 4A and 4B illustrate the process.

### Implementation of Slope Adjustment of CCLM

Slope adjustment parameter is provided as an integer between −4 and 4, inclusive, and signalled in the bitstream. The unit of the slope adjustment parameter is (⅛)-th of a chroma sample value per luma sample value (for 10-bit content).

Adjustment is available for the CCLM models that are using reference samples both above and left of the block (e.g. “LM_CHROMA_IDX” and “MMLM_CHROMA_IDX”), but not for the “single side” modes. This selection is based on coding efficiency versus complexity trade-off considerations. “LM_CHROMA_IDX” and “MMLM_CHROMA_IDX” refers to CCLM_LT and MMLM_LT in this invention. The “single side” modes refer to CCLM_L, CCLM_T, MMLM_L, and MMLM_T in this invention.

When slope adjustment is applied for a multi-model CCLM mode, both models can be adjusted and thus up to two slope updates are signalled for a single chroma block.

### Encoder Approach for Slope Adjustment of CCLM

The proposed encoder approach performs an SATD (Sum of Absolute Transformed Differences) based search for the best value of the slope update for Cr and a similar SATD based search for Cb. If either one results as a non-zero slope adjustment parameter, the combined slope adjustment pair (SATD based update for Cr, SATD based update for Cb) is included in the list of RD (Rate-Distortion) checks for the TU.

### Convolutional Cross-Component Model (CCCM)-Single Model and Multi-Model

In CCCM, a convolutional model is applied to improve the chroma prediction performance. The convolutional model has 7-tap filter consisting of a 5-tap plus sign shape spatial component, a nonlinear term and a bias term. The input to the spatial 5-tap component of the filter consists of a centre (C) luma sample which is collocated with the chroma sample to be predicted and its above/north (N), below/south(S), left/west (W) and right/east (E) neighbours as shown in FIG. 5.

The nonlinear term (denoted as P) is represented as power of two of the centre luma sample C and scaled to the sample value range of the content:

$$P = ( C * C + midVal ) ≫ bitDepth .$$

For example, for 10-bit contents, the nonlinear term is calculated as:

$$P = ( C * C + 512 ) ≫ 10$$

The bias term (denoted as B) represents a scalar offset between the input and output (similarly to the offset term in CCLM) and is set to the middle chroma value (512 for 10-bit content).

Output of the filter is calculated as a convolution between the filter coefficients cᵢ and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B$$

The filter coefficients cᵢ are calculated by minimising MSE between predicted and reconstructed chroma samples in the reference area. FIG. 6 illustrates an example of the reference area which consists of 6 lines of chroma samples above and left of the PU. Reference area extends one PU width to the right and one PU height below the PU boundaries. Area is adjusted to include only available samples. The extensions to the area (indicated as “paddings”) are needed to support the “side samples” of the plus-shaped spatial filter in FIG. 5 and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

### Gradient Linear Model (GLM)

Compared with the CCLM, instead of down-sampled luma values, the GLM utilizes luma sample gradients to derive the linear model. Specifically, when the GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β$$

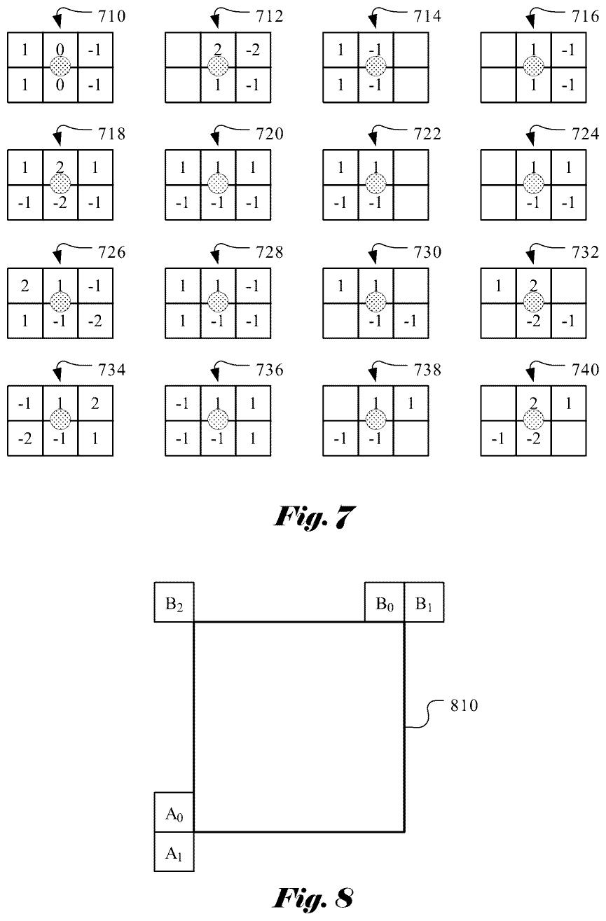

For signalling, when the CCLM mode is enabled for the current CU, two flags are signalled separately for Cb and Cr components to indicate whether GLM is enabled for each component. If the GLM is enabled for one component, one syntax element is further signalled to select one of 16 gradient filters (710-740 in FIG. 7) for the gradient calculation. The GLM can be combined with the existing CCLM by signalling one extra flag in bitstream. When such combination is applied, the filter coefficients that are used to derive the input luma samples of the linear model are calculated as the combination of the selected gradient filter of the GLM and the down-sampling filter of the CCLM.

### Spatial Candidate Derivation

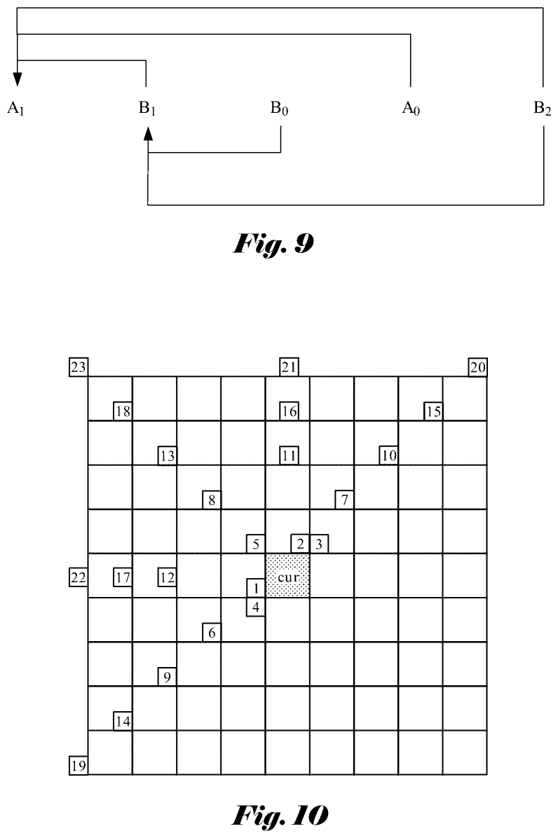

The derivation of spatial merge candidates in VVC is the same as that in HEVC except that the positions of first two merge candidates are swapped. A maximum of four merge candidates for current CU 810 are selected among candidates located in the positions depicted in FIG. 8. The order of derivation is B₀, A₀, B₁, A₁ and B₂. Position B₂ is considered only when one or more neighbouring CU of positions B₀, A₀, B₁, A₁ are not available (e.g., belonging to another slice or tile) or is intra coded. After candidate at position A₁ is added, the addition of the remaining candidates is subject to a redundancy check which ensures that candidates with the same motion information are excluded from the list so that coding efficiency is improved. To reduce computational complexity, not all possible candidate pairs are considered in the mentioned redundancy check. Instead, only the pairs linked with an arrow in FIG. 9 are considered and a candidate is only added to the list if the corresponding candidate used for redundancy check does not have the same motion information.

### Non-Adjacent Spatial Candidate

During the development of the VVC standard, a coding tool referred as Non-Adjacent Motion Vector Prediction (NAMVP) has been proposed in JVET-L0399 (Yu Han, et al., “CE4.4.6: Improvement on Merge/Skip mode”, Joint Video Exploration Team (JVET) of ITU-T SG 16 WP 3 and ISO/IEC JTC 1/SC 29/WG 11, 12th Meeting: Macao, CN, 3-12 Oct. 2018, Document: JVET-L0399). According to the NAMVP technique, the non-adjacent spatial merge candidates are inserted after the TMVP (i.e., the temporal MVP) in the regular merge candidate list. The pattern of spatial merge candidates is shown in FIG. 10. The distances between non-adjacent spatial candidates and current coding block are based on the width and height of current coding block. In FIG. 10, each small square corresponds to a NAMVP candidate and the candidates are ordered (as shown by the number inside the square) according to the distance. The line buffer restriction is not applied. In other words, the NAMVP candidates far away from a current block may have to be stored that may require a large buffer.

In order to improve performance of cross-component prediction, methods and apparatus to generate a default cross-component candidate for merge candidate list are disclosed as follows.

### Inheriting Neighbouring Model Parameters for Refining the Cross-Component Model Parameters

The final scaling parameter of the current block is inherited from the neighbouring blocks and further refined by dA. Once the final scaling parameter is determined (e.g., the inherited scaling parameter is refined), the offset parameter (e.g., β in CCLM) is derived based on the inherited scaling parameter and the average value of neighbouring luma and chroma samples of the current block. For example, if the final scaling parameter is inherited from a selected neighbouring block, and the inherited scaling parameter is α′ₙₑᵢ, then the final scaling parameter is (α′ₙₑᵢ+dA). For yet another embodiment, the final scaling parameter is inherited from a historical list and further refined by dA. For example, the historical list records the most recent j entries of final scaling parameters from previous CCLM-coded blocks. Then, the final scaling parameter is inherited from one selected entry of the historical list, α′ₗᵢₛₜ, and the final scaling parameter is (α′ₗᵢₛₜ+dA). For yet another embodiment, the final scaling parameter is inherited from a historical list or the neighbouring blocks, but only the MSB (Most Significant Bit) part of the inherited scaling parameter is taken, and the LSB (Least Significant Bit) of the final scaling parameter is from dA. For yet another embodiment, the final scaling parameter is inherited from a historical list or the neighbouring blocks, but does not further refine by dA.

For yet another embodiment, after inheriting model parameters, the offset parameter can be further refined by dB. For example, if the final offset parameter is inherited from a selected neighbouring block, and the inherited offset parameter is β′ₙₑᵢ, then the final offset parameter is (β′ₙₑᵢ+dB). For still another embodiment, the final offset parameter is inherited from a historical list and further refined by dB. For example, the historical list records the most recent j entries of final scaling parameters from previous CCLM-coded blocks. Then, the final scaling parameter is inherited from one selected entry of the historical list, β′ₗᵢₛₜ, and the final scaling parameter is (β′ₗᵢₛₜ+dB). For yet another embodiment, the final offset parameter is inherited from a historical list or the neighbouring blocks, but is not further refined by dB.

For yet another embodiment, if the inherited neighbour block is coded with CCCM, the filter coefficients (cᵢ) are inherited. The offset parameter (e.g., c₆×B or c₆ in CCCM) can be re-derived based on the inherited parameter and the average value of neighbouring corresponding position luma and chroma samples of the current block. For still another embodiment, only partial filter coefficients are inherited (e.g., only n out of 7 filter coefficients are inherited, where 1≤n<7), the rest filter coefficients are further re-derived using the neighbouring luma and chroma samples of the current block.

For still another embodiment, if the inherited candidate applies GLM gradient pattern to its luma reconstructed samples, the current block shall also inherit the GLM gradient pattern of the candidate and apply to the current luma reconstructed samples.

For still another embodiment, if the inherited neighbour block is coded with multiple cross-component models (e.g., MMLM, or CCCM with multi-model), the classification threshold is also inherited to classify the neighbouring samples of the current block into multiple groups, and the inherited multiple cross-component model parameters are further assigned to each group. For yet another embodiment, the classification threshold is the average value of the neighbouring reconstructed luma samples, and the inherited multiple cross-component model parameters are further assigned to each group. Similarly, once the final scaling parameter of each group is determined, the offset parameter of each group is re-derived based on the inherited scaling parameter and the average value of neighbouring luma and chroma samples of each group of the current block. For another example, if CCCM with multi-model is used, once the final coefficient parameter of each group is determined (e.g., c₀ to c₅ except for c₆ in CCCM), the offset parameter (e.g., c₆×B or c₆ in CCCM) of each group is re-derived based on the inherited coefficient parameter and the neighbouring luma and chroma samples of each group of the current block.

For still another embodiment, inheriting model parameters may depend on the colour component. For example, Cb and Cr components may inherit model parameters or model derivation method from the same candidate or different candidates. For yet another example, only one of colour components inherits model parameters, and the other colour component derives model parameters based on the inherited model derivation method (e.g., if the inherited candidate is coded by MMLM or CCCM, the current block also derives model parameters based on MMLM or CCCM using the current neighbouring reconstructed samples). For still another example, only one of colour components inherits model parameters, and the other colour component derives its model parameters using the current neighbouring reconstructed samples.

For still another example, if Cb and Cr components can inherit model parameters or model derivation method from different candidates. The inherited model of Cr can depend on the inherited model of Cb. For example, possible cases include but not limited to (1) if the inherited model of Cb is CCCM, the inherited model of Cr shall be CCCM; (2) if the inherit model of Cb is CCLM, the inherit model of Cr shall be CCLM; (3) if the inherited model of Cb is MMLM, the inherited model of Cr shall be MMLM; (4) if the inherited model of Cb is CCLM, the inherited model of Cr shall be CCLM or MMLM; (5) if the inherited model of Cb is MMLM, the inherited model of Cr shall be CCLM or MMLM; (6) if the inherited model of Cb is GLM, the inherited model of Cr shall be GLM.

For yet another embodiment, after decoding a block, the Cross-Component Model (CCM) information of the current block is derived and stored for later reconstruction process of neighbouring blocks using inherited neighbouring model parameters. The CCM information mentioned in this disclosure includes but not limited to prediction mode (e.g., CCLM, MMLM, CCCM), GLM pattern index, model parameters, or classification threshold. For example, even the current block is coded by inter prediction, the cross-component model parameters of the current block can be derived by using the current luma and chroma reconstruction or prediction samples. Later, if another block is predicted by using inherited neighbours model parameters, it can inherit the model parameters from the current block. For another example, the current block is coded by cross-component prediction, the cross-component model parameters of the current block are re-derived by using the current luma and chroma reconstruction or prediction samples. For another example, the stored cross-component model can be CCCM, LM_LA (i.e., single model LM using both above and left neighbouring samples to derive model), or MMLM_LA (It's also denoted as MMLM_LT. It's multi-model LM using both above and left neighbouring samples to derive model). For still example, even the current block is coded by non-cross-component intra prediction (e.g., DC, planar, intra angular modes, MIP, or ISP), the cross-component model parameters of the current block are derived by using the current luma and chroma reconstruction or prediction samples.

For another example, even the current block is coded by cross-component prediction, the cross-component model parameters of the current block are re-derived by using the current luma and chroma reconstruction or prediction samples. Later the re-derived model parameters are combined with the original cross-component models which is used in reconstructing the current block. For combining with the original cross-component models, it can use the model combination methods mentioned in sections entitled: Models Generated Based on Other Inherited Models and entitled: Inheriting Multiple Cross-Component Models. For example, assume the original cross-component model parameters are

$$\{ {c}_{0}^{0} , {c}_{1}^{0} , ... , {c}_{M - 1}^{0} \} ,$$

and the re-derived cross-component model parameters are

$$\{ {c}_{0}^{0} , {c}_{1}^{0} , ... , {c}_{M - 1}^{0} \} .$$

The final cross-component model can be

$$\{ ( 1 - α ) \times {c}_{0}^{0} + α \times {c}_{0}^{1} , ( 1 - α ) \times {c}_{1}^{0} + α \times {c}_{1}^{1} , ... , ( 1 - α ) \times {c}_{M - 1}^{0} + α \times {c}_{M - 1}^{1} \} ,$$

where α is a weighting factor which can be predefined or implicitly derived according to neighbouring template cost.

For another embodiment, when inheriting a cross-component model from a neighbour merge candidate that was coded by a cross-component mode (e.g. CCLM and CCCM, . . . ), a flag can be signalled to indicate/select if the re-derived model is used. If the flag is 0, the cross-component model used to encode the neighbour merge candidate is inherited. If the flag is 1, the cross-component model re-derived based on the luma and chroma reconstruction or prediction samples of the neighbour merge candidate is inherited.

For still another example, when the current slice is a non-intra slice (e.g., P slice or B slice), a cross-component model of the current block is derived and stored for later reconstruction process of neighbouring blocks using inherited neighbouring model parameters. For still another embodiment, when the current block is inter-coded, the CCM information of the current inter-coded block is derived by copying the CCM information from its reference block that has CCM information in a reference picture, located by the motion information of the current inter-coded block. For example, as shown in FIG. 11, the block B in a P/B picture 1120 is inter-coded, then the CCM information of block B is obtained by copying CCM information from its referenced block A in an I picture 1110. It should be noted that the current block can also copy the CCM information from an intra-coded block in an P/B picture. For example, as shown in the FIG. 11, the block D in a P/B picture 1130 is inter-coded, then the CCM information of block B is obtained by copying CCM information from its referenced block E that is intra-coded in the P/B picture 1120. For still another embodiment, if the reference block in a reference picture is also inter-coded, the CCM information of the reference block is obtained by copying the CCM information from another reference block in another reference picture. For example, as shown in the FIG. 11, the current block C in a current P/B picture 1130 is inter-coded and its referenced block B is also inter-coded, due to the CCM information of block B is obtained by copying the CCM information from block A, then the CCM information of block A is also propagated to the current block C. For still another embodiment, when the current block is inter-coded with bi-directional prediction, if one of its reference blocks is intra-coded and has CCM information, the CCM information of the current block is obtained by copying the CCM information from its intra-coded reference block in a reference picture. For example, suppose block Fis inter-coded with bi-prediction and has reference blocks G and H. Block G is intra-coded and has CCM information. The CCM information of block F is obtained by copying the CCM information from the block G coded in CCM mode. For still another embodiment, when the current block is inter-coded with bi-directional prediction, the CCM information of the current block is the combination of the CCM models of its reference blocks (as the method mentioned in section entitled: Inheriting Multiple Cross-Component Models).

When deriving cross-component models for the current block by using the current luma and chroma reconstruction or prediction samples, in one embodiment, if the current derived model error is greater than a threshold, the current derived model is discarded and not stored. For example, it can input the current luma reconstruction samples to the model, calculate the distortion between the model output and the current chroma reconstruction samples, and then the calculated distortion is normalized by the current block size or number of samples used in calculating the distortion. If the normalized distortion is greater than or equal to a threshold, the current derived model is discarded and not stored.

Whether to derive cross-component models for the current block or not may depend on the current block size or area. For example, for small blocks (e.g., block width/height less than or equal to a threshold, or block area less than or equal a threshold), it is not allowed to derive cross-component models. For another example, for large blocks (e.g., block width/height greater than or equal to a threshold, or block area greater than or equal a threshold), it is not allowed to derive cross-component models.

### Inheriting CCM Information

In one embodiment, the Cross-Component Model (CCM) information of inherited cross-component model can be stored together with the inherited model parameters. As mentioned earlier in this disclosure, the CCM information includes, but not limited to prediction mode (e.g., CCLM, MMLM, CCCM), model index for indicating which model shape is used in convolutional model, classification threshold for multi-model, down-sampling filter flag, down-sampling filtering index, number of neighbouring lines used to derive model, types of templates used to derive model, post-filtering flag or model parameters.

In one embodiment, CCLM model can be inherited. In addition to storing model parameters, a prediction mode can be stored in the CCM information for indicating that the inherited model is a CCLM model.

In another embodiment, CCLM model with non-linear term can be inherited. In addition to storing model parameters, a prediction mode can be stored in the CCM information for indicating that the inherited model is a CCLM model with one or more non-linear terms.

In one embodiment, CCCM model can be inherited. In addition to storing model parameters, a prediction mode can be stored in the CCM information for indicating that the inherited model is a CCCM model. The luma offset and the chroma offset used for adjusting the input of CCCM model can also be stored in the CCM information.

In another embodiment, CCCM model with different convolution filter shape can be inherited. In addition to model parameters and prediction mode, a CCCM mode index can also be stored in CCM information for indicating which convolution filter shape is used for the inherited CCCM model. For example, a CCCM model with different convolution filter shape can only contain the spatial terms in the horizontal direction. For another example, a CCCM model with different convolution filter shape can only contain the spatial terms in vertical direction. For another example, a CCCM model with different convolution filter shape can only contain the spatial terms in diagonal direction. For another example, a CCCM model with different convolution filter shape can only contain the spatial terms in anti-diagonal direction. For another example, a CCCM model with different convolution filter shape can contain the X-shape spatial terms.

In another embodiment, CCCM model using non-downsampled samples can be inherited. In addition to storing model parameters, a prediction mode can be stored in the CCM information for indicating that the inherited model is a CCCM model using non-downsampled samples.

In another embodiment, CCCM model with multiple down-sampling filters can be inherited. In addition to storing model parameters, a prediction mode can be stored in the CCM information for indicating that the inherited model is a CCCM model with multiple down-sampling filters, and a model index can be also stored in CCM information for indicating which variant of CCCM model with multiple down-sampling filters is inherited.

In another embodiment, a mixed CCCM model consist of various terms (e.g. spatial term, gradient term, location term, non-linear term and bias term) can be inherited. The gradient term can be calculated in either the downsampled domain or the non-downsampled domain. The location term can be calculated with respect to the top-left coordinates of the current block or the picture. In addition to storing model parameters, a prediction mode can be stored in the CCM information for indicating that the inherited model is a mixed CCCM model consist of various terms. If there are multiple types of mixed CCCM models, a model index can also be stored in the CCM information for indicating which type of mixed CCCM model is inherited. For example, gradient and location based CCCM (GL-CCCM) proposed in JVET-AB0119 (Ramin G. Youvalari, et al., “Non-EE2: Gradient and location based convolutional cross-component model (GL-CCCM) for intra prediction”, Joint Video Exploration Team (JVET) of ITU-T SG 16 WP 3 and ISO/IEC JTC 1/SC 29/WG 11, 28th Meeting, Mainz, DE, 20-28 Oct. 2022, Document: JVET-AB0119) is a mixed CCCM model which consist of one spatial term in centre position, two gradient terms for the horizontal direction and vertical direction, two location terms X and Y for the relative horizontal location and relative vertical location, one non-linear term and one bias term. In addition to storing model parameters, a prediction mode can be stored in the CCM information for indicating that the inherited model is a GL-CCCM model.

In one embodiment, GLM model can be inherited. In addition to storing model parameters, a prediction mode can be stored in the CCM information for indicating that the inherited model is a GLM model, and a down-sampling filtering index can be also stored in CCM information for indicating which gradient down-sampled filter is used for the inherited GLM model.

In another embodiment, GLM model with luma term can be inherited. In addition to storing model parameters, a prediction mode can be stored in the CCM information for indicating that the inherited model is a GLM model with luma term, and a down-sampling filtering index can be also stored in CCM information for indicating which gradient down-sampled filter is used for the inherited GLM model with luma term.

In one embodiment, any kind of cross-component multi-model can be inherited. In addition to storing model parameters and prediction mode, a multi-model on/off flag can be stored in the CCM information for indicating whether the inherited CCM model is a multi-model or not. If the multi-model on/off flag is true, the multi-model classification threshold is also stored in the CCM information.

In one embodiment, the CCM information can include information to indicate how the inherited model is derived. For example, the CCM information can include the number of neighbouring lines used to derive the cross-component model and/or the types of templates used to derive model. For example, a set of templates can be used to derive a CCCM model. The set of templates include template with different positions, sizes, and shapes. The CCM information can store the index of the template that the inherited CCCM model was derived based on. For example, the inherited CCCM model can be derived based on a top-only template, or a left-only template or a left-and-top template. For another example, the inherited CCCM model can be derived based on a 6-line template or a 2-line template.

In one embodiment, a post-filter flag can be stored in the CCM information. This information describes how the inherited model is used in the block the inherited model is from. If the post-filter flag is on, this indicates a filter is applied to the prediction of the block the inherited model is from.

### Inherit Spatial Neighbouring Model Parameters

For another embodiment, the inherited model parameters can be from a block that is an immediate neighbouring block. The models from blocks at pre-defined positions are added into the candidate list in a pre-defined order. For example, the pre-defined positions can be the positions depicted in FIG. 8, and the pre-defined order can be B₀, A₀, B₁, A₁ and B₂, or A₀, B₀, B₁, A₁ and B₂. The block can be a chroma block or a single-tree luma block.

For still another embodiment, the pre-defined positions include the positions immediately above the centre position of the top line of the current block if W is greater than or equal to TH. Assume the position of the current chroma block is at (x, y), the pre-defined positions can be (x+(W>>1), y−1) or (x+(W>>1)−1, y−1). The pre-defined positions also include the positions at the immediate left of the centre position of the left line of the current block if H is greater than or equal to TH. The pre-defined positions can be (x−1, (H>>1)) or (x−1, (H>>1)−1) position. W and H are the width and height of the current chroma block, and TH is a threshold value which can be 2, 4, 8, 16, 32, or 64.

For still another embodiment, the maximum number of inherited models from spatial neighbours are smaller than the number of pre-defined positions. For example, if the pre-defined positions are as depicted in FIG. 8, there are 5 pre-defined positions. If pre-defined order is B₀, A₀, B₁, A₁ and B₂, and the maximum number of inherited models from spatial neighbours is 4, the model from B₂ is added into the candidate list only when one of preceding blocks is not available or is not coded in cross-component model.

### Inheriting Temporal Neighbouring Model Parameters

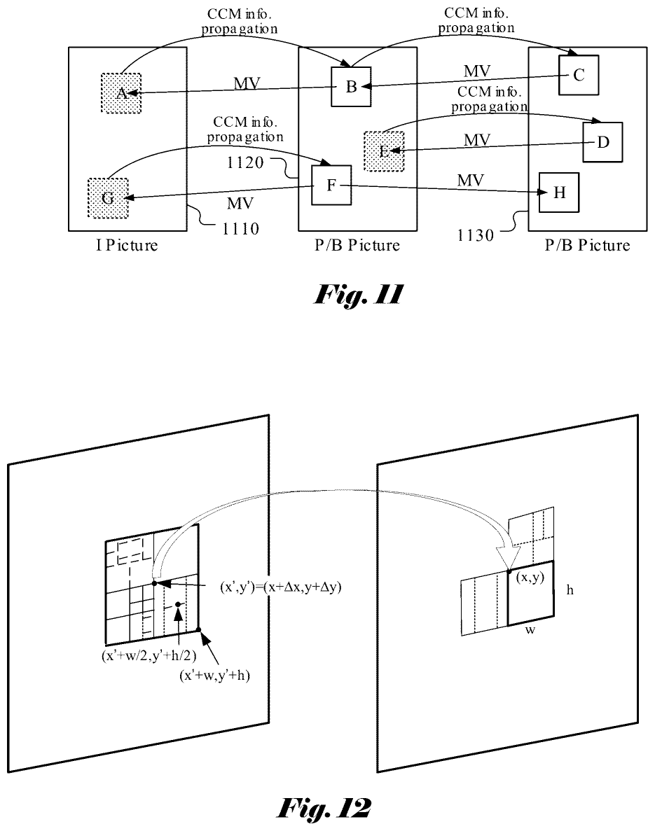

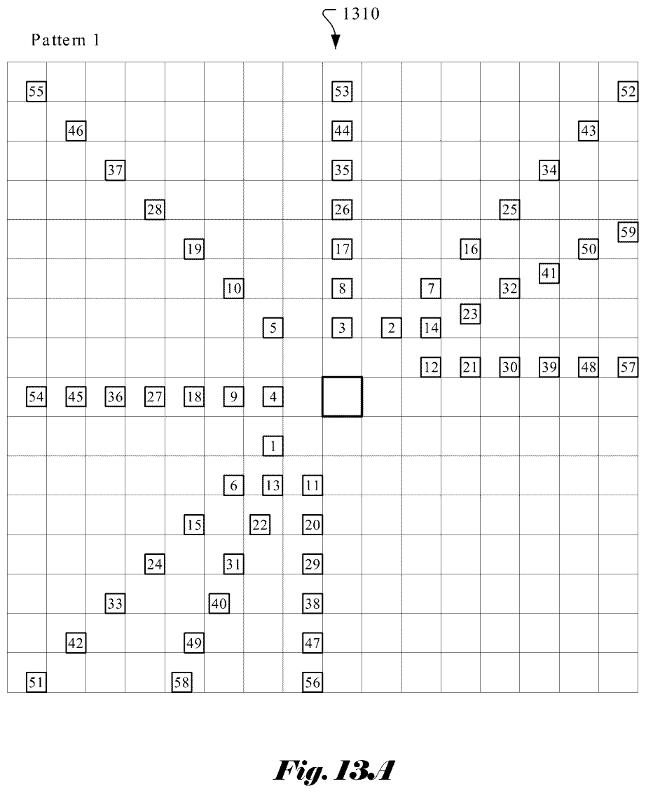

For still another embodiment, if the current slice/picture is a non-intra slice/picture, the inherited model parameters can be from the block in the previous coded slices/pictures. For example, as shown in the FIG. 12, the current block position is at (x, y) and the block size is w×h. The inherited model parameters can be from the block at position (x′, y′), (x′, y′+h/2), (x′+w/2, y′), (x′+w/2, y′+h/2), (x′+w, y′), (x′, y′+h), or (x′+w, y′+h) of the previous coded slices/picture, where x′=x+Δx and y′=y+Δy. In one embodiment, if the prediction mode of the current block is intra, Ax and Ay are set to 0. If the prediction mode of the current block is inter prediction, Ax and Ay are set to the horizontal and vertical motion vectors of the current block. In another embodiment, if the current block is inter bi-prediction, Ax and Ay are set to the horizontal and vertical motion vectors in reference picture list 0. In still another embodiment, if the current block is inter bi-prediction, Ax and Ay are set to the horizontal and vertical motion vectors in reference picture list 1.

For still another embodiment, if the current block is inter bi-prediction, the inherited model parameters can be from the block in the previous coded slices/pictures in the reference lists. For example, if the horizontal and vertical parts of the motion vector in reference picture list 0 are Δx_{L0} and Δy_{L0}, the motion vector can be scaled to other reference pictures in the reference list 0 and 1. If the motion vector is scaled to the i^{th} reference picture in the reference list 0 as (Δx_{L0,i0}, Δy_{L0,i0}). The model can be from the block in the i^{th} reference picture in the reference list 0, and Ax and Ay are set to (Δx_{L0,i0}, Δy_{L0,i0}). For another example, if the horizontal and vertical parts of the motion vector in reference picture list 0 are Δx_{L0} and Δy_{L0}, the motion vector is scaled to the i^{th} reference picture in the reference list 1 as (Δx_{L0,i1}, Δy_{L0,i1}). The model can be from the block in the i^{th} reference picture in the reference list 1, and Δx and Δy are set to (Δx_{L0,i1}, Δy_{L0,i1}).

### Inherit Non-Adjacent Spatial Neighbouring Models

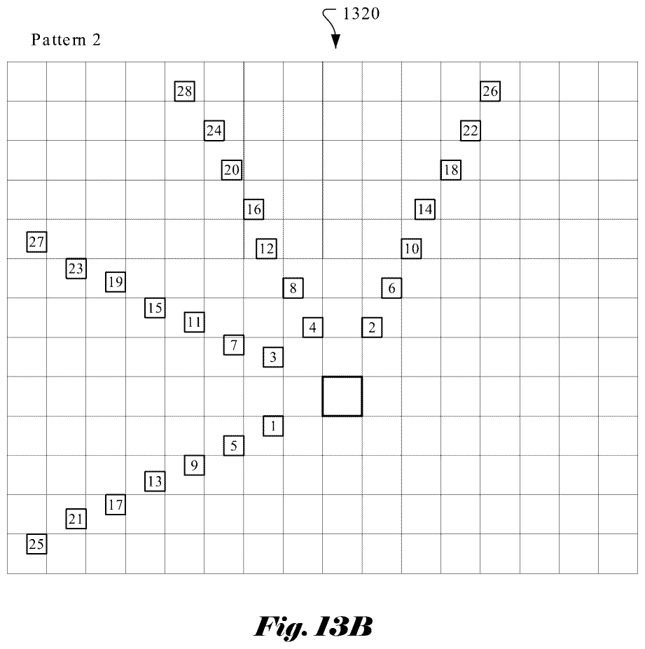

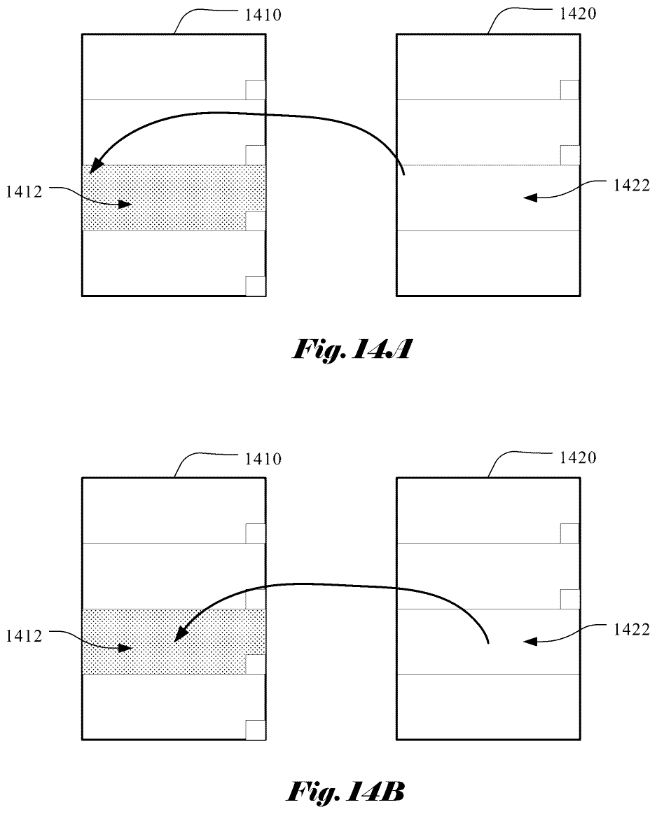

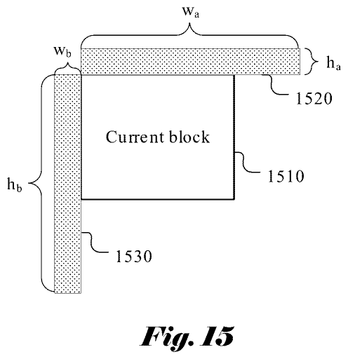

For another embodiment, the inherited model parameters can be from blocks that are adjacent and non-adjacent spatial neighbouring blocks. The models from blocks at pre-defined positions are added into the candidate list in a pre-defined order. For example, the pattern of the positions and order can be as the pattern depicted in FIG. 10, where the distance between each position is the width and height of current coding block. Each small square represents a candidate position and the number inside the square indicates the pre-defined order. The distances between each position and the current block are based on the width and height of the current coding block. For another example, the positions and the order can be as depicted in FIG. 13, where two patterns (1310 and 1320) are shown. Each small square represents a candidate position and the number inside the square indicates the pre-defined order. The positions in pattern 1 (1310) are added into the candidate list before the positions in pattern 2 (1320). The distances between each position and the current block are based on the width and height of the current coding block.

For another embodiment, the distances between the positions that are closer to the current encoding block are smaller than the distances between the positions that are further away from the current block.

For still another embodiment, the maximum number of inherited models from non-adjacent spatial neighbours are smaller than the number of pre-defined positions. Here the maximum number refers to the maximum number of candidates that can be added into the candidate list. For example, the pre-defined positions are as depicted in FIGS. 13A-B, where two patterns (pattern 1310 in FIG. 13A and pattern 1320 in FIG. 13B) are shown. If the maximum number of inherited models from non-adjacent spatial neighbours is N, the search pattern 2 is used only when the number of available models from search pattern 1 is smaller than N. In other words, if the maximum number of inherited models from non-adjacent spatial neighbours is N, the models from positions in pattern 2 (1320) in FIG. 13B are added into the candidate list only when the number of available cross-component models from positions in pattern 1 (1310) in FIG. 13A is smaller than N.

Inheriting Model Parameters from History Table

In one embodiment, the inherited model parameters can be from a cross-component model history table. The cross-component models in the history table can be added into the candidate list according to a pre-defined order. In one embodiment, the adding order of historical candidates can be from the beginning of the table to the end of the table. In another embodiment, the adding order of historical candidates can be from a certain pre-defined position to the end of the table. In another embodiment, the adding order of historical candidates can be from the end of the table to the beginning of the table. In another embodiment, the adding order of historical candidates can be from a certain pre-defined position to the beginning of the table. In another embodiment, the adding order of historical candidates can be in an interleaved manner (e.g., the first added candidate is from the beginning of the table, the second added candidate is from the end of the table and so on).

In one embodiment, single cross-component model history table can be maintained for storing the previous cross-component model, and the cross-component model history table can be reset at the start of the current picture, current slice, current tile, every M CTU rows or every N CTUs, where N and M can be any value greater than 0. In another embodiment, the cross-component model history table can be reset at the end of the current picture, current slice, current tile, current CTU row or current CTU.

In another embodiment, one picture can be divided into multiple regions, and for each region, a history table is kept. The history table 0 and one additional history table will be updated during the encoding/decoding process. The additional history table can be determined by the current position. For example, if the current CU is located in the second region, the additional history table to be updated is history table 2.

In another embodiment, multiple history tables are used for different updated frequencies. For example, the first history table is updated every CU, the second history table is updated every two CUs, the third history table is updated every four CUs and so on.

In another embodiment, multiple history tables are used for storing different types of cross-component models. For example, the first history table is used for storing single model, and the second history table is used for storing multi-model. For another example, the first history table is used for storing gradient models, and the second history table is used for storing non-gradient models. For another example, the first history table is used for storing simple linear models (e.g., y=ax+b), and the second history table is used for storing complicated models (e.g., CCCM).

In another embodiment, multiple history tables are used for different reconstructed luma intensities. For example, if the average of reconstructed luma samples in the current block is greater than a pre-defined threshold, the cross-component model will be stored in the first history table; otherwise, the cross-component model will be stored in the second history table. In another embodiment, multiple history tables are used for different reconstructed chroma intensities. For example, if the average of neighbouring reconstructed chroma samples in the current block is greater than a pre-defined threshold, the cross-component model will be stored in the first history table; otherwise, the cross-component model will be stored in the second history table.

In one embodiment, when adding historical candidates from multiple history tables to the candidate list, the adding order can be from the beginning of the certain table to the end of the certain table, and then add the next history table in the same order or in a reversed order. In another embodiment, the adding order can be from the end of the certain table to the beginning of the certain table, and then add the next history table in the same order or in a reversed order. In another embodiment, the adding order can be from the certain pre-defined position of the certain table to the end of the certain table, and then add the next history table in the same order or in a reversed order. In another embodiment, the adding order can be from the certain pre-defined position of the certain table to the beginning of the certain table, and then add the next history table in the same order or in a reversed order. In another embodiment, the adding order of historical candidates can be in an interleaved manner in a certain history table (e.g., the first added candidate is from the beginning of the certain history table, the second added candidate is from the end of the certain history table and so on), and then add the next history table in the same order or in a reversed order.

In another embodiment, the adding order can be from the beginning of each history table to the end of each history table. In another embodiment, the adding order can be from the end of each history table to the beginning of each history table. In another embodiment, the adding order can be from the certain pre-defined position of each history table to the end of each history table. In another embodiment, the adding order can be from the certain pre-defined position of each history table to the beginning of each history table. In another embodiment, the adding order of historical candidates can be in an interleaved manner in each certain history table (e.g., the first added candidates are from the beginning of all history tables, the second added candidates are from the end of all history tables and so on).

In one embodiment, multiple cross-component model history tables are used, but not all history tables will be used for creating the candidate list. Only history tables whose regions are close to the region of current block can be used to create the candidate list.

In one embodiment, if the historical candidates are used, the range for selecting non-adjacent candidates can be reduced by using a smaller distance between each position of non-adjacent candidate. In another embodiment, if the historical candidates are used, the number of non-adjacent candidates can be reduced by measuring the distance from the left-top position of the current block to the candidate position and then excluding the candidate with the distance greater than a pre-defined threshold. In another embodiment, if the historical candidates are used, the number of non-adjacent candidates can be reduced by skipping the candidates that are not located in the same region. In another embodiment, if the historical candidates are used, the number of non-adjacent candidates can be reduced by skipping the candidates that are not located in the neighbouring regions. The range of neighbouring regions is pre-defined, and the range can be M by N, where M and N can be any value greater than 0. In another embodiment, if the historical candidates are used, the range for selecting non-adjacent candidates can be reduced by skipping the second search pattern.

In another embodiment, one picture can be divided into multiple regions, and at least one history table is kept in each region. For a region of the current picture, it can use or combine the history tables of one or multiple regions in the previous coded pictures as the initial history table. For example, if a picture is divided into N regions, it can implicitly or explicitly select the history table from one of N regions in the previous coded pictures as the initial history table. The index of one of N regions can be signalled or implicitly derived from the corresponding region in the previous coded pictures. As shown in FIGS. 14A-B, where the current picture 1420 is a P/B coded picture and the previous picture 1410 is an Intra coded picture. Each picture is divided into 4 regions as shown in 4 rectangular boxes. According to an embodiment of the present invention, the corresponding region in the previous coded pictures can be the region 1412 having the same beginning geometric position as the current region 1422 as shown in FIG. 14A or containing the centre geometric position of the current region 1422 as shown in FIG. 14B. For another example, it can combine more than one history tables in the previous coded regions/pictures to construct the history table of the current region.

### Models Generated Based on Other Inherited Models

In another embodiment, a single cross-component model can be generated from a multiple cross-component model. The single cross-component model can then be added into the candidate list.

In one embodiment, after inherited candidates (e.g., spatial neighbour candidates, temporal neighbour candidates, non-adjacent neighbour candidates or history candidates) are added in the candidate list, if there exist candidates coded with multiple cross-component models (e.g., MMLM, CCCM with multi-model, or other CCCM variants with multi-model), a single cross-component model can be generated based on the existing multiple cross-component models. As described in “Multiple Model CCLM (MMLM)” and “Convolutional cross-component model (CCCM)-single model and multi-model”, let the model used for samples in group 1 be denoted as model 1 and the model used for samples in group 2 be denoted as model 2, a single cross-component model (e.g., CCLM or CCCM) can be generated by selecting model 1 or model 2.

In one embodiment, both model 1 and model 2 are added into the candidate list. In another embodiment, only model 1 is added into the candidate list. For another example, only model 2 is added into the candidate list.

### Candidate List Construction

In one embodiment, the candidate list is constructed by adding candidates in a pre-defined order until the maximum candidate number is reached. The candidates added may include all or some of the aforementioned candidates, but not limited to the aforementioned candidates. For example, the candidate list may include spatial neighbouring candidates, temporal neighbouring candidate, historical candidates, non-adjacent neighbouring candidates, single model candidates generated based on other inherited models (as mentioned in section entitled: Models Generated Based on Other Inherited Models) or combined model (as mentioned later in section entitled: Inheriting Multiple Cross-Component Models). For another example, the candidate list includes the same candidates as previous example, but the candidates are added into the list in a different order.

In another embodiment, if all the pre-defined neighbouring and historical candidates are added but the maximum candidate number is not reached, some default candidates are added into the candidate list until the maximum candidate number is reached.

In one sub-embodiment, the default candidates include but not limited to the candidates described below. The default candidates are CCLM models: pred_{C}(i, j)=α·rec_{L}′(i, j)+β. The final scaling parameter α is from the set {0, ⅛, −⅛, + 2/8, − 2/8, +⅜, −⅜, + 4/8, − 4/8}, and the offset parameter β=1/(1<<bit_depth) or is derived based on neighbouring luma and chroma samples. For example, if the average value of neighbouring luma and chroma samples are lumaAvg and chromaAvg, then β is derived by β=chromaAvg−α·lumaAvg. The average value of neighbouring luma samples (i.e., lumaAvg) can be calculated by all selected luma samples, the luma DC mode value of the current luma CB (Coding Block), or the average of the maximum and minimum luma samples

$$( e . g . , lumaAvg = ( Max ( {x}_{A}^{0} , {x}_{A}^{1} ) + Min ( {x}_{B}^{0} , {x}_{B}^{1} ) + 1 ) ≫ 1 , or lumaAvg = ( Min ( {x}_{A}^{0} , {x}_{A}^{1} ) + Max ( {x}_{B}^{0} , {x}_{B}^{1} ) + 1 ) ≫ 1 ) .$$

Similarly, average value of neighbouring chroma samples (i.e., chromaAvg) can be calculated by all selected chroma samples, the chroma DC mode value of the current chroma CB, or the average of the maximum and minimum chroma samples

$$( e . g . , chromaAvg = ( Max ( {y}_{A}^{0} , {y}_{A}^{1} ) + Min ( {y}_{B}^{0} , {y}_{B}^{1} ) + 1 ) ≫ 1 , or chromaAvg = ( Min ( {y}_{A}^{0} , {y}_{A}^{1} ) + Max ( {y}_{B}^{0} , {y}_{B}^{1} ) + 1 ) ≫ 1 ) .$$

In another sub-embodiment, the default candidates include but not limited to the candidates described below. The default candidates are GLM models: α·G+β, where G is the luma sample gradients instead of down-sampled luma samples L. The 16 GLM filters described in the section, entitled: Gradient Linear Model (GLM), are applied. The final scaling parameter a is from the set {0, ⅛, −⅛, + 2/8, − 2/8, +⅜, −⅜, + 4/8, − 4/8}. The offset parameter β=1/(1<<bit_depth) or is derived based on neighbouring luma and chroma samples.

In another embodiment, a default candidate can be derived based on an earlier candidate (i.e., a candidate added earlier in the candidate list) with a delta scaling parameter refinement. For example, if the scaling parameter of an earlier candidate is a, the scaling parameter of a default candidate is (α+Δα), where Δα can be from the set {⅛, −⅛, + 2/8, − 2/8, +⅜, −⅜, + 4/8, − 4/8}. And the offset parameter of a default candidate would be derived by (α·Δα) and the average value of neighbouring luma and chroma samples of the current block.

In another embodiment, a default candidate can be a shortcut to indicate a cross-component mode (i.e., using the current neighbouring luma/chroma reconstruction samples to derive cross-component models) rather than inheriting parameters from neighbours. For example, a default candidate can be CCLM_LA, CCLM_L, CCLM_A, MMLM_LA, MMLM_L, MMLM_A, single-model CCCM, multiple-model CCCM or cross-component model with a specified GLM pattern. The terms of {CCLM_LA, CCLM_A, MMLM_LA, MMLM_A} and {CCLM_LT, CCLM_T, MMLM_LT, MMLM_T} are used interchangeably in this disclosure.

In another embodiment, a default candidate can be a cross-component mode (i.e., using the current neighbouring luma/chroma reconstruction samples to derive cross-component models) rather than inheriting parameters from neighbours, and also with a scaling parameter update (Δα). Then, the scaling parameter of a default candidate is (α+Δα). For example, a default candidate can be CCLM_LA, CCLM_L, CCLM_A, MMLM_LA, MMLM_L, or MMLM_A. For another example, Δα can be from the set {⅛, −⅛, + 2/8, − 2/8, +⅜, −⅜, + 4/8, − 4/8}. And the offset parameter of a default candidate can be derived by (α+Δα) and the average value of neighbouring luma and chroma samples of the current block. For still another example, the Ax can be different for each colour components.

In another embodiment, a default candidate can be an earlier candidate with partial selected model parameters. For example, suppose an earlier candidate has m parameters, it can choose k out of m parameters from the earlier candidate to be a default candidate, where 0<k<m and m>1.

In another embodiment, a default candidate can be the first model of an earlier MMLM candidate (i.e., the model used when the sample value is less than or equal to the classification threshold). In still another embodiment, a default candidate can be the second model of an earlier MMLM candidate (i.e., the model used when the sample value is greater than or equal to the classification threshold). In still another embodiment, a default candidate can be the combination of two models of an earlier MMLM candidate. For example, if the models of an earlier MMLM candidate are

$$\{ {c}_{0}^{0} , {c}_{1}^{0} , ... , {c}_{M - 1}^{0} \} and \{ {c}_{0}^{0} , {c}_{1}^{0} , ... , {c}_{M - 1}^{0} \} .$$

The model parameters of an default candidate can be

$$\{ ( 1 - α ) \times {c}_{0}^{0} + α \times {c}_{0}^{1} , ( 1 - α ) \times {c}_{1}^{0} + α \times {c}_{1}^{1} , … , ( 1 - α ) \times {c}_{M - 1}^{0} + α \times {c}_{M - 1}^{1} \} ,$$

where α is a weighting factor which can be predefined or implicitly derived according to neighbouring template cost, and

$${c}_{x}^{y}$$

is the x-th parameter of the y-th model.

In another embodiment, default candidates can be derived from reconstructed samples from non-adjacent neighbouring regions. Let the current block position be at (x, y) and the block size be w×h. If the reconstructed samples in the M×N region located at (x+dx, y+dy) are available, the default candidates can be derived using reconstructed luma and chroma samples in the region. For example, M×N can be 8×8. For another example, M×N can be 16×8. For another example, M×N can be 16×16. For another example, M×N can be w×h.

In another embodiment, let the current block position be at (x, y) and the block size be w×h, the default candidates can be derived using reconstructed samples in the M×N region located at (x_{mid}+dx, y_{mid}+dy), if the reconstructed samples in the region are available. (x_{mid}, y_{mid})=(x+w/2, y+h/2).

In another embodiment, default candidates derived from reconstructed samples from non-adjacent neighbouring regions can be any type of cross-component model or some particular types of cross-component model. For example, the derived model can be CCLM, MMLM, CCCM, CCCM multi-models, or other cross-component models. For another example, the derived model is CCCM model. For another example, the derived model is CCLM model. For another example, the derive model is CCCM or CCCM multi-models.

In another embodiment, assume two value sets αₓ and α_{y} are defined as:

$${α}_{x} = \{ {α}_{x 1} , {α}_{x 2} , {α}_{x 3} , … , {α}_{xn} \} , {α}_{xi} < {α}_{xj} if i < j$$

$${α}_{y} = \{ {α}_{y 1} , {α}_{y 2} , {α}_{y 3} , … , {α}_{yn} \} , {α}_{yi} < {α}_{yj} if i < j$$

All values in αₓ and α_{y} are positive numbers. (dx, dy) could be (αₓᵢ×w, −α_{yi}×h), (−αₓᵢ×w, α_{yi}×h), (−αₓᵢ×w, −α_{yi}×h), (αₓᵢ×W, 0), (−αₓᵢ×w, 0), (0, α_{yi}×h), (0, y_{mid}−α_{yi}×h).

In another embodiment, the current block position is at (x, y) and the block size is w×h. Let δx and δy be two fixed positive numbers (dx, dy) could be (αₓᵢ×δx, −α_{yi}×δy), (−αₓᵢ×δx, +α_{yi}×δy), (−αₓᵢ×δx, −α_{yi}×δy)

When constructing a candidate list, candidates are inserted into the list according to a pre-defined order. For example, the pre-defined order can be spatial adjacent candidates, temporal candidates, spatial non-adjacent candidates, historical candidates, and then default candidates. In one embodiment, if cross-component models are derived for non-LM coded blocks (e.g., as mentioned in the section entitled: Inheriting Neighbouring Model Parameters for Refining the Cross-Component Model Parameters), the candidate models of non-LM coded blocks are included into the list after including candidate models of LM coded blocks. In another embodiment, if cross-component models are derived for non-LM coded blocks, the candidate models of non-LM coded blocks are included into the list before including default candidates. In still another embodiment, if cross-component models are derived for non-LM coded blocks, the candidate models of non-LM coded blocks have lower priority to be included into the list than candidate models from LM coded blocks.

When constructing a candidate list, only the candidates with a certain prediction mode can be added into the list. For example, only the candidates derived by CCLM or MMLM modes are allowed to be added into the list. For another example, only the candidates derived by single-model modes (e.g., CCLM, or CCCM with single-model) are allowed to be added into the list. For another example, only the candidates derived by multi-model modes (e.g., MMLM, or CCCM with multi-model) are allowed to be added into the list. For another example, only the candidates derived by GLM modes are allowed to be added into the list. For another example, only the candidates derived by a specific mode (e.g., CCLM, MMLM, CCCM, CCCM with multi-model, or GLM) are allowed to be added into the list. In one embodiment, if only the candidate with a certain prediction mode can be added into the list, when doing prediction mode signalling, it can signal the prediction mode first and then signal if the proposed cross-component merge mode is used or not. If the proposed cross-component merge mode is used, then signal the candidate index.

### Reordering the Candidates in the List

The candidates in the list can be reordered to reduce the syntax overhead when signalling the selected candidate index. The reordering rules can depend on the coding information of neighbouring blocks or the model error. For example, if neighbouring above or left blocks are coded by MMLM, the MMLM candidates in the list can be moved to the head of the current list. Similarly, if neighbouring above or left blocks are coded by single model LM or CCCM, the single model LM or CCCM candidates in the list can be moved to the head of the current list. Similarly, if GLM is used by neighbouring above or left blocks, the GLM related candidates in the list can be moved to the head of the current list.

In still another embodiment, the reordering rule is based on the model error by applying the candidate model to the neighbouring templates of the current block, and then compare the error with the reconstructed samples of the neighbouring template. For example, as shown in FIG. 15, the size of above neighbouring template 1520 of the current block is wₐ×hₐ, and the size of left neighbouring template 1530 of the current block 1510 is w_{b}×h_{b}. Suppose K models are in the current candidate list, and αₖ and βₖ are the final scaling and offset parameters after inheriting the candidate k. The model error of candidate k corresponding to the above neighbouring template is:

$${e}_{a}^{k} = {\sum }_{i , j} \vert ( {α}_{k} \times r e c {L}_{a}^{′ ( i , j )} + {β}_{k} ) - r e c {C}_{a}^{( i , j )} \vert$$

where,

$$r e c {L}_{a}^{′ ( i , j )} and {recC}_{a}^{( i , j )}$$

are the reconstructed samples of luma (e.g., after downsampling process or after applying GLM pattern) and reconstructed samples of chroma at position (i, j) in the above template, and 0≤i<wₐ and 0≤j<hₐ.

Similarly, the model error of candidate k by the left neighbouring template is:

$${e}_{b}^{k} = {\sum }_{m , n} \vert ( {α}_{k} \times r e c {L}_{b}^{′ ( m , n )} + {β}_{k} ) - r e c {C}_{b}^{( m , n )} \vert$$

where

$$r e c {L}_{b}^{′ ( m , n )} and {recC}_{b}^{( m , n )}$$

are the reconstructed samples of luma (e.g., after applying downsampling process or GLM pattern) and reconstructed samples of chroma at position (m, n) in the left template, and 0≤m<w_{b} and 0≤n<h_{b}.

Then the model error of candidate k is:

$${e}^{k} = {e}_{a}^{k} + {e}_{b}^{k}$$

After calculating the model error among all candidates, it can get a model error list E={e⁰, e¹, e², . . . , e^{k}, . . . , e^{K}}. Then, it can reorder the candidate index in the inherited candidate list by sorting the model error list in ascending order.

In still another embodiment, if the candidate k uses CCCM prediction, the

$${e}_{a}^{k} and {e}_{b}^{k}$$

are defined as:

$${e}_{a}^{k} = {\sum }_{i , j} \vert ( c {0}_{k} \times r e c {L}_{a}^{′ ( i , j )} + c {1}_{k} \times r e c {L}_{a}^{′ ( i , j - 1 )} + c {2}_{k} \times r e c {L}_{a}^{′ ( i , j + 1 )} + c {3}_{k} \times r e c {L}_{a}^{′ ( i - 1 , j )} + c {4}_{k} \times r e c {L}_{a}^{′ ( i + 1 , j )} + c {5}_{k} \times P + c {6}_{k} \times B ) - rec {C}_{a}^{( i , j )} \vert$$

$${e}_{b}^{k} = {\sum }_{i , j} \vert ( c {0}_{k} \times r e c {L}_{b}^{′ ( i , j )} + c {1}_{k} \times r e c {L}_{b}^{′ ( i , j - 1 )} + c {2}_{k} \times r e c {L}_{b}^{′ ( i , j + 1 )} + c {3}_{k} \times r e c {L}_{b}^{′ ( i - 1 , j )} + c {4}_{k} \times r e c {L}_{b}^{′ ( i + 1 , j )} + c {5}_{k} \times P + c {6}_{k} \times B ) - {recC}_{b}^{( i , j )} \vert$$

where c0ₖ, c1ₖ, c2ₖ, c3ₖ, c4ₖ, c5ₖ, and c6ₖ are the final filtering coefficients after inheriting the candidate k. P and B are the nonlinear term and bias term.

In still another embodiment, if the above neighbouring template is not available, then

$${e}^{k} = {e}_{b}^{k} .$$

Similarly, if the left neighbouring template is not available, then

$${e}^{k} = {e}_{a}^{k} .$$

If both templates are not available, the candidate index reordering method using model error is not applied.

In still another embodiment, not all positions inside the above and left neighbouring template are used in calculating model error. It can choose partial positions inside the above and left neighbouring template to calculate model error. For example, it can define a first start position and a first subsampling interval depending on the width of the current block to partially select positions inside the above neighbouring template. Similarly, it can define a second start position and a second subsampling interval depending on the height of the current block to partially select positions inside the left neighbouring template.

In another embodiment, hₐ or w_{b} can be a constant value (e.g., hₐ or w_{b} can be 1, 2, 3, 4, 5, or 6). For another embodiment, hₐ or w_{b} can be dependent on the block size. If the current block size is greater than or equal to a threshold, hₐ or w_{b} is equal to a first value. Otherwise, hₐ or w_{b} is equal to a second value.

In still another embodiment, the candidates of different types are reordered separately before the candidates are added into the final candidate list. For each type of the candidates, the candidates are added into a primary (or a preparatory) candidate list with a pre-defined size N₁. The candidates in the primary (or a preparatory) list are reordered. The N₂ candidates with the smallest costs are then added into the final candidate list, where N₂≤N₁. In another embodiment, the candidates are categorized into different types based on the source of the candidates, including but not limited to the spatial neighbouring models, temporal neighbouring models, non-adjacent spatial neighbouring models, and the historical candidates. In another embodiment, the candidates are categorized into different types based on the cross-component model mode. For example, the types can be CCLM, MMLM, CCCM, and CCCM multi-model. For another example, the types can be GLM-non active or GLM active.

In still another embodiment, after the candidates are reordered based on the template cost, the redundancy of the candidate can be further checked. A candidate is considered to be redundant if the template cost difference between the candidate and its predecessor in the list is smaller than a threshold. If a candidate is considered redundant, it can be removed from the list, or it can be move to the end of the list.

### Signalling the Inherited Candidate Index in the List

An on/off flag can be signalled to indicate if the current block inherits the cross-component model parameters from neighbouring blocks or not. The flag can be signalled per CU/CB, per PU, per TU/TB, or per colour component, or per chroma colour component. A high-level syntax can be signalled in SPS, PPS (Picture Parameter Set), PH (Picture header) or SH (Slice Header) to indicate if the proposed method is allowed for the current sequence, picture, or slice.

The maximum allowed candidate number is signalled to indicate the maximum size of the merge candidate list. The number can be signalled per CU/CB, per PU, per TU/TB, or per colour component, or per chroma colour component. A high level syntax can be signalled in SPS, PPS, PH or SH to indicate if the proposed method is allowed for the current sequence, picture, or slice. The maximum allowed candidate number of the proposed method can be shared with the maximum allowed candidate number for inter merge mode.

If the current block inherits the cross-component model parameters from neighbouring blocks, the inherited candidate index is signalled. The index can be signalled (e.g., signalled using truncate unary code, Exp-Golomb code, or fix length code) and shared among both the current Cb and Cr blocks. For another example, the index can be signalled per colour component. For example, one inherited candidate index is signalled for Cb component, and another inherited candidate index is signalled for Cr component. For another example, it can use chroma intra prediction syntax (e.g., IntraPredModeC[xCb][yCb]) to store the inherited candidate index.

If the current block inherits the cross-component model parameters from neighbouring blocks, the current chroma intra prediction mode (e.g., IntraPredModeC[xCb][yCb] as defined in VVC standard) is temporally set to a cross-component mode (e.g., CCLM_LA) at the bitstream syntax parsing stage. Later, at the prediction stage or reconstruction stage, the candidate list is derived, and the inherited candidate model is then determined by the inherited candidate index. After obtaining the inherited model, the coding information of the current block is then updated according to the inherited candidate model. The coding information of the current block includes but not limited to the prediction mode (e.g., CCLM_LA or MMLM_LA), related sub-mode flags (e.g., CCCM mode flag), prediction pattern (e.g., GLM pattern index), and the current model parameters. Then, the prediction of the current block is generated according to the updated coding information.

### Inheriting Multiple Cross-Component Models

The final prediction of the current block can be the combination of predictions of multiple cross-component models, or fusion of the prediction of selected cross-component models with the prediction by non-cross-component coding tools (e.g., intra angular prediction modes, intra planar/DC modes, or inter prediction modes). In one embodiment, if the current candidate list size is N, it can select k candidates from the total N candidates (where k≤N). Then, k predictions are respectively generated by applying the cross-component model of the selected k candidates using the corresponding luma reconstruction samples. The final prediction of the current block is the combination results of these k predictions. For example, if two candidate predictions (denoted as p_{cand1} and p_{cand2}) are combined, the final prediction at (x, y) position of the current block is p_{final}(x, y)=(1−α)×p_{cand1}(x, y)+α×p_{cand2}(x, y), where α is a weighting factor. Besides, the weighting factor α can be predefined or implicitly derived according to neighbouring template cost (i.e., model error). For example, by using the template cost defined in the section entitled: Reordering the Candidates in the List, the corresponding template cost of two candidates are e^{cand1} and e^{cand2}, then α is e^{cand1}/(e^{cand1}+e^{cand2}). In another embodiment, if two candidate models are combined, the selected models are from the first two candidates in the list. In still another embodiment, if i candidate models are combined, the selected models are from the first i candidates in the list.

In another embodiment, if the current candidate list size is N, it can select k candidates from the total N candidates (where k≤N). The k cross-component models can be combined into one final cross-component model by weighted-averaging the corresponding model parameters. For example, if a cross-component model has M parameters, the j-th parameter of the final cross-component model is the weighted-averaging of the j-th parameter of the k selected candidates, where j is 1 . . . . M. Then, the final prediction is generated by applying the final cross-component model to the corresponding luma reconstructed samples. For example, if two candidate models are

$$\{ {c}_{0}^{0} , {c}_{1}^{0} , … , {c}_{M - 1}^{0} \} and \{ {c}_{0}^{1} , {c}_{1}^{1} , … , {c}_{M - 1}^{1} \} .$$

The final cross-component model is

$$\{ ( 1 - α ) \times {c}_{0}^{0} + α \times {c}_{0}^{1} , ( 1 - α ) \times {c}_{1}^{0} + α \times {c}_{1}^{1} , … , ( 1 - α ) \times {c}_{M - 1}^{0} + α \times {c}_{M - 1}^{1} \} ,$$

where α is a weighting factor which can be predefined or implicitly derived according to neighbouring template cost, and

$${c}_{x}^{y}$$

is the x-th model parameter of the y-th candidate. For example, by using the template cost defined in the section entitled: Reordering the Candidates in the List, the corresponding template cost of two candidates are e^{cand1} and e^{cand2}, then a is e^{cand1}/(e^{cand1}+e^{cand2}). For still an example, for the two candidate models, one is from the spatial adjacent neighbouring candidates, and another one is from the non-adjacent spatial candidates or history candidates. If the spatial adjacent neighbouring candidates are not available, then the two candidate models are all from the non-adjacent spatial candidates or history candidates. In another embodiment, if two candidate models are combined, the selected models are from the first two candidates in the list. In still another embodiment, if i candidate models are combined, the selected models are from the first i candidates in the list, where i is an integer greater than 1.

In another embodiment, two cross-component models are combined into one final model by weighted-averaging the corresponding model parameters. One of the two cross-component models is from the above spatial neighbouring candidate and another one is from the left spatial neighbouring candidate. The above spatial neighbouring candidate is the neighbouring candidate that has the vertical position less than or equal to the top block boundary position of the current block. The left spatial neighbouring candidate is the neighbouring candidate that has the horizontal position less than or equal to the left block boundary position of the current block. The weighting factor α is determined according to the horizontal and vertical spatial positions inside the current block. For example, if two candidate predictions (denoted as p_{above} and p_{left}) are combined, the final prediction at (x, y) position of the current block is p_{final}(x, y)=(1−α)×p_{above}(x, y)+α×p_{left}(x, y), where α=y/(x+y). In another embodiment, the above spatial neighbouring candidate is the first candidate in the list that has the vertical position less than or equal to the top block boundary position of the current block. The left spatial neighbouring candidate is the first candidate in the list that has the horizontal position less than or equal to the left block boundary position of the current block.

In another embodiment, it can combine cross-component model candidates with the prediction of non-cross-component coding tools. For example, one cross-component model candidate is selected from the candidate list, and its prediction is denoted as p_{ccm}. Another prediction can be from chroma DM, chroma DIMD, or intra angular mode, and denoted as p_{non-ccm}. The final prediction at (x, y) position of the current block is p_{final}(x, y)=(1−α)λp_{ccm}(x,y)+α×p_{non-ccm}(x, y), where a is the weighting factor which can be predefined or implicitly derived according to neighbouring template cost. For still the same example, the non-cross-component coding tool can be predefined or signalled. The non-cross-component coding tool is chroma DM or chroma DIMD. For another example, the non-cross-component coding tool is signalled, but the index of cross-component model candidate is predefined or determined by the coding modes of neighbouring blocks. For still the same example, if at least one of neighbouring spatial blocks is coded with CCCM mode, the first candidate has CCCM model parameters is selected. If at least one of neighbouring spatial blocks is coded with GLM mode, the first candidate has GLM pattern parameters is selected. Similarly, if at least one of neighbouring spatial blocks is coded with MMLM mode, the first candidate has MMLM parameters is selected.

In another embodiment, it can combine the prediction of cross-component model candidates with the prediction by the current cross-component model. For example, one cross-component model candidate is selected from the list, and its prediction is denoted as p_{ccm}. Another prediction can be from the cross-component prediction mode whose model is derived by the current neighbouring reconstructed samples and is denoted as p_{curr-ccm}. The final prediction at (x, y) position of the current block is p_{final}(x, y)=(1−α)×p_{ccm}(x, y)+α×p_{curr-cm}(x, y), where a is the weighting factor which can be predefined or implicitly derived according to neighbouring template cost. For still the same example, the prediction by the current cross-component model can be predefined or signalled. The prediction by the current cross-component coding tool is CCCM_LT, LM_LT (i.e., single model LM using both top and left neighbouring samples to derive the model), or MMLM_LT (i.e., multi-model LM using both top and left neighbouring samples to derive the model). In one embodiment, the selected cross-component model candidate is the first candidate in the list.

In another embodiment, it can combine multiple cross-component models into one final cross-component model. For example, it can choose one model from a candidate, and choose a second model from another candidate to form a multi-model mode. The selected candidate can be CCLM/MMLM/GLM/CCCM coded candidate. The multi-model classification threshold can be the average of the offset parameters (e.g., offset/β in CCLM, or c₆×B or c₆ in CCCM) of the two selected modes. In one embodiment, if two candidate models are combined, the selected models are the first two candidates in the list. In another embodiment, the classification threshold is set to the average value of the neighbouring luma and chroma samples of the current block.

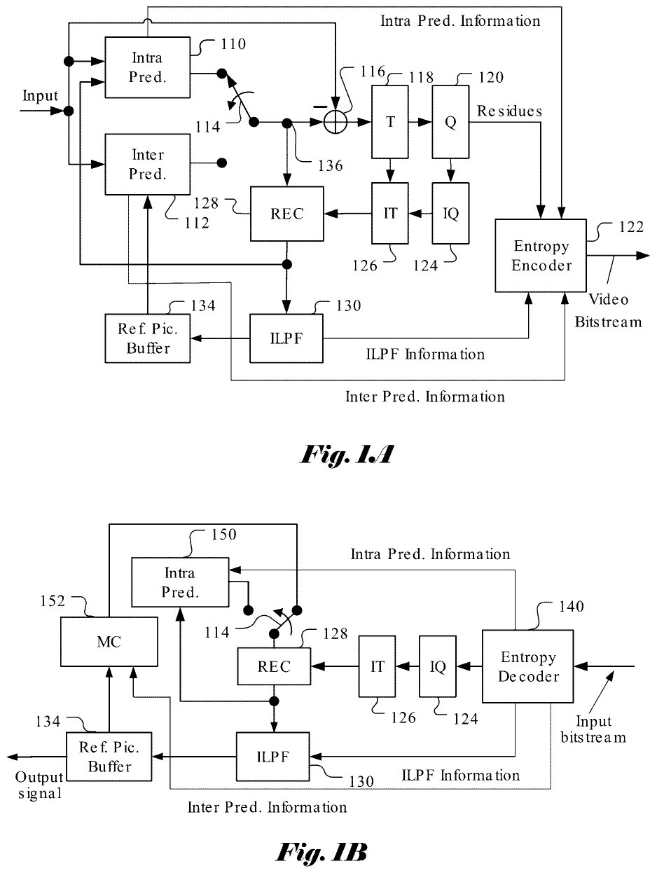

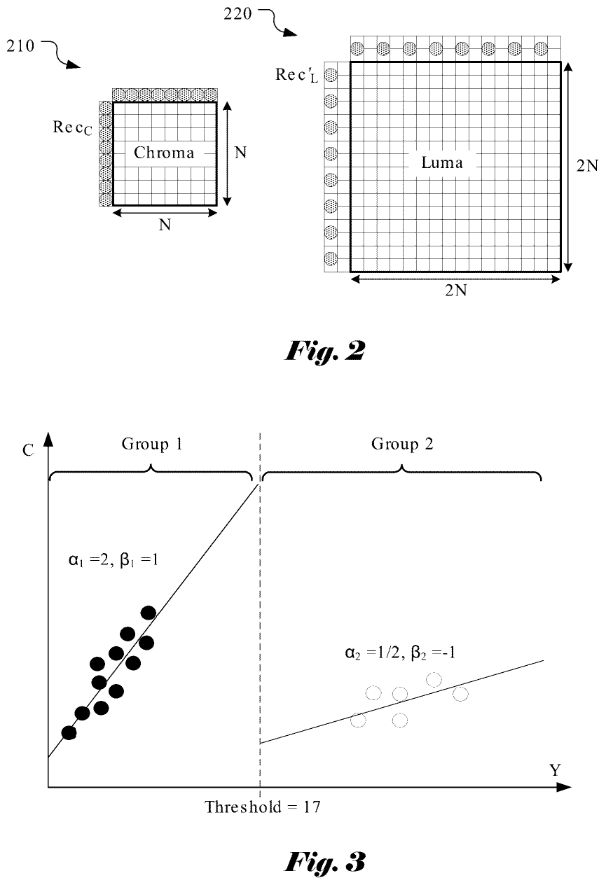

Any of the foregoing proposed default cross-component model derivation methods can be implemented in encoders and/or decoders. For example, any of the proposed methods can be implemented in an inter/intra/prediction module of an encoder, and/or an inter/intra/prediction module of a decoder. Alternatively, any of the proposed methods can be implemented as a circuit coupled to the inter/intra/prediction module of the encoder and/or the inter/intra/prediction module of the decoder, so as to provide the information needed by the inter/intra/prediction module. For example, any of the proposed candidate reordering methods can be implemented in an Intra/Inter coding module (e.g. Intra Pred. 150/MC 152 in FIG. 1B) in a decoder or an Intra/Inter coding module is an encoder (e.g. Intra Pred. 110/Inter Pred. 112 in FIG. 1A). Any of the proposed methods can also be implemented as a circuit coupled to the intra/inter coding module at the decoder or the encoder. However, the decoder or encoder may also use additional processing unit to implement the required cross-component prediction processing. While the Intra Pred. units (e.g. unit 110/112 in FIG. 1A and unit 150/152 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

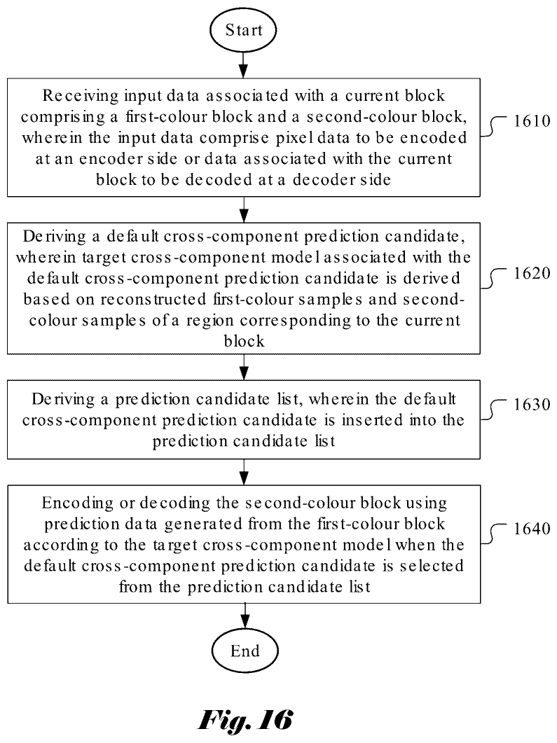

FIG. 16 illustrates a flowchart of an exemplary video coding system that incorporates a scheme to derive a default cross-component candidate according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data associated with a current block comprising a first-colour block and a second-colour block are received in step 1610, wherein the input data comprise pixel data to be encoded at an encoder side or data associated with the current block to be decoded at a decoder side. A default cross-component prediction candidate is derived in step 1620, wherein the target cross-component model associated with the default cross-component prediction candidate is derived based on reconstructed first-colour samples and second-colour samples of a region corresponding to the current block. A prediction candidate list is derived in step 1630, wherein the default cross-component prediction candidate is inserted into the prediction candidate list. The second-colour block is encoded or decoded using prediction data generated from the first-colour block according to the target cross-component model when the default cross-component prediction candidate is selected from the prediction candidate list in step 1640.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of coding colour pictures using coding tools including one or more cross component models related modes, the method comprising:
receiving input data associated with a current block comprising a first-colour block and a second-colour block, wherein the input data comprise pixel data to be encoded at an encoder side or data associated with the current block to be decoded at a decoder side;
deriving a default cross-component prediction candidate, wherein target cross-component model associated with the default cross-component prediction candidate is derived based on reconstructed first-colour samples and second-colour samples of a region corresponding to the current block;
deriving a prediction candidate list, wherein the default cross-component prediction candidate is inserted into the prediction candidate list; and
encoding or decoding the second-colour block using prediction data generated from the first-colour block according to the target cross-component model when the default cross-component prediction candidate is selected from the prediction candidate list.

2. The method of claim 1, wherein the region corresponding to the current block is defined by x and y coordinates of location of the region and region width and region height.

3. The method of claim 1, wherein size of the region corresponding to the current block is the same as block size of the current block.

4. The method of claim 1, wherein size of the region corresponding to the current block is pre-defined.

5. The method of claim 1, wherein location of the region corresponding to the current block is identified by an offset position from a target current position in a reconstructed area, and wherein the target current position corresponds to an upper-left position, middle position or lower-right position of the current block.

6. The method of claim 5, wherein the offset position is selected from a group of candidate locations, and wherein x-coordinates of the candidate locations are proportional to a first base and y-coordinates of the candidate locations are proportional to a second base, and the first base and the second base are positive values.

7. The method of claim 6, wherein the first base corresponds to width of the current block and the second base corresponds to height of the current block.

8. The method of claim 6, wherein the first base and the second base are pre-defined.

9. The method of claim 6, wherein the x-coordinates of the candidate locations are generated by multiplying the first base with a first set of numbers and the y-coordinates of the candidate locations are generated by multiplying the second base with a second set of numbers.

10. The method of claim 9, wherein the first set of numbers comprises 0, ±1, . . . , ±M and the second set of numbers comprises 0, ±1, . . . , ±N, and wherein M and N are positive integers greater than 0.

11. The method of claim 9, wherein the first set of numbers comprises 0, ±1, . . . , ±M and the second set of numbers comprises 0, ±½, . . . , ±N/2, and wherein M and N are positive integers greater than 0.

12. The method of claim 1, wherein the target cross-component model corresponds to CCCM (Convolutional Cross-Component Model), MM-CCCM (Multiple Model CCCM) or CCLM (Cross-Component Linear Model).

13. The method of claim 1, wherein the target cross-component model belongs to a model group comprising CCLM (Cross-Component Linear Model), MMLM (Multiple Model CCLM), CCCM (Convolutional Cross-Component Model), and MM-CCCM (Multiple Model CCCM).

14. The method of claim 1, wherein when the target cross-component model associated with the default cross-component prediction candidate is derived based on the reconstructed first-colour samples and the second-colour samples of a non-adjacent region of the current block, the target cross-component model corresponds to any type of cross-component models.

15. The method of claim 1, wherein when the target cross-component model associated with the default cross-component prediction candidate is derived based on the reconstructed first-colour samples and the second-colour samples of a non-adjacent region of the current block, the target cross-component model corresponds to some particular types of cross-component models.

16. An apparatus for video coding, the apparatus comprising one or more electronics or processors arranged to:
receive input data associated with a current block comprising a first-colour block and a second-colour block, wherein the input data comprise pixel data to be encoded at an encoder side or data associated with the current block to be decoded at a decoder side;
derive a default cross-component prediction candidate, wherein target cross-component model associated with the default cross-component prediction candidate is derived based on reconstructed first-colour samples and second-colour samples of a region corresponding to the current block;
derive a prediction candidate list, wherein the default cross-component prediction candidate is inserted into the prediction candidate list; and
encode or decode the second-colour block using prediction data generated from the first-colour block according to the target cross-component model when the default cross-component prediction candidate is selected from the prediction candidate list.
